(19) United States
(12) Patent Application Publication
(10) Pub. No.: US 2006/0168212 A1
(43) Pub. Date: Jul. 27, 2006

(54) Security system and method

(75) Inventors: Bernard Parsons, LONDON (GB); Gordon Parrott, London (GB)

Correspondence Address: DARBY & DARBY P.C., P. O. BOX 5257, NEW YORK, NY, 10150-5257, US

(73) Assignee: BECRYPT LIMITED, READING (GB)

(21) Appl. No.: 10/539,910

(22) PCT Filed: Dec. 22, 2003
(86) PCT No.: PCT/GB03/05632

§ 371 Date: Jun. 15, 2005

(30) Foreign Application Priority Data
Dec. 20, 2002 (GB) 0229759.6

(51) Int. Cl. G06F 15/173

(52) U.S. Cl. 709/225; 709/217

(57) ABSTRACT

A security system and method are disclosed that are particularly suitable for a portable electronic device having a memory. The security system interacts with the electronic device to acquire at least a portion of the memory of the electronic device, and controls access to the acquired memory independently of an operating system of the electronic device. The acquired protected memory may be used for storing encryption/decryption key or key(s) for an encryption system.

### FIELD OF THE INVENTION

The present invention relates to a method and system for securing electronic equipment having a memory, such as a personal computer, personal digital assistant (PDA), mobile telephone and the like.

### BACKGROUND TO THE INVENTION

A problem with many portable computing devices other devices capable of providing portable computing services is that they have limitations in terms of processing power and of the software provided to operate them. Yet, these devices are often used to store sensitive information. In fact, many such devices, in particular portable digital assistants, fail to achieve baseline certification, for example by the Communications & Electronics Security Group (CESG) of the UK's GCHQ (Government Communications Head Quarters). This lack of security is a significant issue that restricts current uses of such portable devices.

The most common way of securing data is by use of an encryption system. However, encryption systems typically require the use of an encryption/decryption key. Relatively weak encryption systems, such as those available for portable devices, use a short length key such as a password that a user is required to remember and input to access encrypted data. However, data encrypted using such systems can be decrypted relatively easily without the password, thereby limiting such systems' worth. In more sophisticated computer systems, a longer, more complex, encryption/decryption key is used. Due to its length and/or complexity, it is not normally possible for a user to remember such a key so instead the key is normally held on the computer system. The key itself is protected within the computer system to prevent unauthorized access. Whilst this protection is straightforward in established desktop and server computer systems where user access permissions can be set at the operating system level, such security functionality is typically limited or omitted in portable devices and this prevents effective implementation of strong encryption systems.

The present invention seeks to provide a security system for such portable devices.

### STATEMENT OF INVENTION

According to an aspect of the present invention, there is provided a security system for an electronic device having a memory, the security system comprising means arranged to interact with the electronic device to acquire at least a portion of the memory of the electronic device, and an access system arranged to control access to the acquired memory.

In a preferred aspect, the present invention seeks to provide a system in which a portion of memory is acquired from the operating system of a device. Access control is implemented such that the memory can only be accessed through the security system and cannot be accessed directly through the operating system.

Preferably the acquired memory is hidden from the operating system.

Preferably, a memory management system of the operating system is manipulated to remove references to the acquired memory.

Preferably, the acquired memory is for the exclusive use of the security system.

The acquired memory could be used for the operation of the security system and/or may be made available for use by other systems or applications.

Advantageously, the security system is operable to control access registers of the memory management unit.

In the preferred embodiment, the security device includes a hidden memory section within the device's memory not accessible by the device's operating system. The hidden memory section provides hidden storage space for functions of the security system.

In a preferred embodiment, the security system is used to store an encryption key for use in an encryption system.

According to another aspect of the present invention, there is provided a method of protecting at least a portion of a memory of an electronic device comprising the steps of: interacting with the electronic device to acquire at least a portion of the memory of the electronic device and controlling access to the acquired memory.

One embodiment implements the security system in the form of a filter driver referred to herein as the encrypting driver. The encrypting driver implements a strategy for the protection of an encryption key used for data encryption.

The principal feature of the preferred embodiments is that the system acquires a portion of memory from the operating system. Preferably, this is achieved by interacting directly with the memory management unit (MMU). The system applies access control to the acquired memory. Whilst access control might not be achieved through the operating system directly, MMU registers may be accessed and modified such that memory becomes unavailable to the system.

The preferred embodiments can provide a security product for mobile computing devices such as personal digital assistants (PDAs), mobile telephones and personal computers, and in particular a comprehensive set of security features, including an encryption component for the transparent encryption of all data stored on removable memory cards (SD/Compact Flash cards). The preferred embodiments seek to achieve baseline certification by the Communications & Electronics Security Group (CESG) of GCHQ (Government Communications Head Quarters).

One embodiment of system is designed for use by devices operated by the Windows CE® operating system.

With protection provided with Windows CE, all physical memory pages are accessible to kernel code or device drivers running with system privileges. Thus, under normal operation, potentially rogue or malicious code can interfere with key material wherever placed. The operating system does not provide the facility to modify this behavior.

In Microsoft Windows (RTM) based systems, the configuration of the operating system is dependent upon the contents of a system database referred to as the registry. Unlike the registry used on desktop operating systems, the Windows CE® registry does not support access control security. Any application on the PDA can access and modify registry settings on PDA's running Windows CE®.

The preferred embodiments implement a mechanism whereby at least selected values of registry settings can be enforced such that they cannot be modified by other applications. This is enforced by:
a) maintaining an internal representation of the correct values of specific registry entries;
b) regularly monitoring registry contents; and
c) resetting registry entries where incorrect values are detected.

The security provided by registry enforcing functionality results from the fact that the functionality is implemented within the encryption driver, which interacts directly with the MMU. The driver would be difficult for a rogue application to stop (unload). Furthermore, unloading the driver would cause the system to enter an unstable state.

### BRIEF DESCRIPTION OF THE DRAWINGS

Embodiments of the present invention are described below, by way of example only, with reference to the accompanying drawings, in which:

FIG. 1 shows an example of electronic device and an embodiment of security system, in which a hidden memory section is created;

FIG. 2 shows an operational view of the system of FIG. 1 in which access to look-aside buffers has been modified by the security system;

FIG. 3 shows an operational view of the system of FIGS. 1 and 2 in which the processor is switched to a supervisor mode;

FIG. 4 shows an embodiment of filter-driver encryption for the security system;

FIG. 5 shows an embodiment of virtual to physical address translation.

### DETAILED DESCRIPTION

The main embodiment described below is described in relation to an electronic device which uses the Windows CE® operating system. However, the security system disclosed herein is independent of operating system so could be applied to electronic devices which use different operating systems. Prior to describing this embodiment, there is described an overview of the system.

In broad terms, the preferred embodiments provide a mechanism for the acquisition and subsequent protection of a portion of memory of an electronic device.

In a preferred application of the present invention, the memory is used for storage and protection of encryption key material within microprocessor-based cryptographic systems. Protection of key material is a central concern in the design of systems that attempt to protect data through the process of data encryption. Where hardware platforms employ standard operating systems, the level of security achievable by a software-based cryptographic module is limited by the security-related characteristics of the operating system. The mechanism outlined below, allows a level of security to be achieved that is dependent upon characteristics of the hardware platform, thereby providing a level of independence from operating system characteristics.

The preferred security system consists of a number of distinct phases, these entail:
1) the acquisition of physical memory;
2) the location of references to the acquired physical memory as maintained by hardware components; and
3) controlling access to acquired physical memory for the exclusive use of encryption.

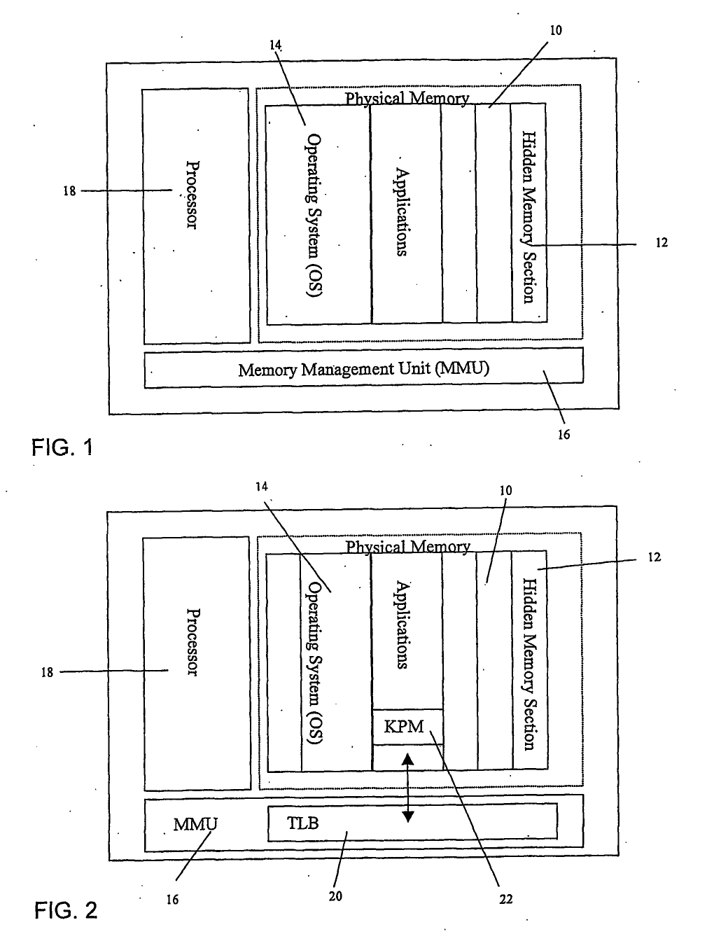

Referring to FIG. 1, the security system acquires a section 12 of memory 10 from the operating system 14 of the electronic device to be protected. The details of the process of memory acquisition is dependent upon the operating system and is therefore not expanded upon here as it will be readily apparent to the skilled person. The result of memory acquisition is the removal of a specific section 12 of physical memory 10 from that regarded as available by the operating system 14. Whilst the security of the security system is not dependent upon the details of memory acquisition, the stability of the operating system is, and should therefore be, considered during the implementation of a memory acquisition scheme.

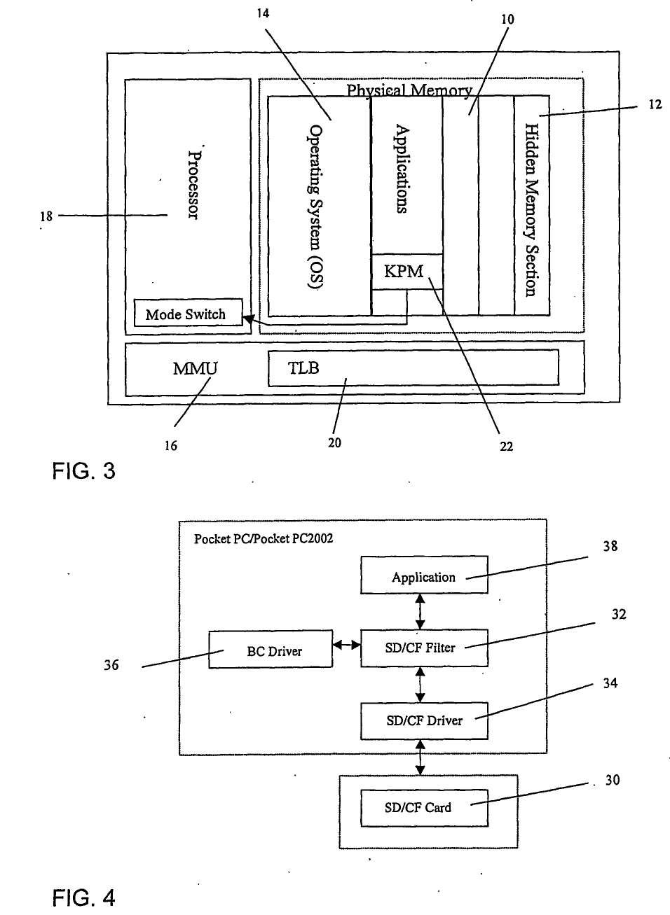

Referring now also to FIGS. 2 and 3, an example of the acquisition of memory by the security system according to an embodiment of the present invention is discussed. In many systems, a software or hardware module referred to as a memory management unit (MMU) 16 is used. MMUs are common within microprocessor-based systems, and support the common use of virtual memory mapping whereby physical memory addresses are mapped to virtual addresses used by the operating system and software applications. The MMU 16 is responsible for managing the system's memory and contains details of physical to virtual memory mapping, memory cache and buffering, and access control information. An operating system 14 is required to initialise an MMU 16 to contain a memory configuration as required by the operating system, following which the MMU 16 maintains configuration data, and interacts directly with the microprocessor 18 during memory read and write operations.

MMU configuration data, referred to as MMU look-up tables, are created within the system's physical memory 10, and maintained internally to the MMU 16 within translation look-aside buffers (TLBs) 20. TLBs 20 create a cached copy of look-up tables for the purpose of fast memory access.

This embodiment includes a software component, referred to here as the key protection module (KPM) 22. The key protection module 22 requires operating system privileges that allow direct access to the physical memory 14. This is typically achieved by implementing a kernel-mode application or driver. The key protection module 22 is required to locate within the MMU look-up tables the entries relating to the memory section acquired as outline above.

Referring now also to FIG. 3, the key protection module 22 identifies a portion of memory to be acquired (ideally a portion of memory that is not used or reserved by the operating system or other applications), modifies access control information within MMU look-up tables such that the identified memory is only accessible during activity initiated by the driver.

The key protection module 22 undertakes a series of write operations to the physical memory 10 containing access control information within MMU look-up tables relating to the acquired memory section. The key protection module 22 then triggers the MMU 16 to update look-aside buffer 20 contents. Any subsequent read or write operations performed by the operating system or applications to the acquired memory running under the operating system will fail.

To protect its own access to the acquired memory, the key protection module 22 utilises microprocessor support of separate processor modes. A processor mode separate to that used for user-applications should employ a separate data stack, and allow code execution that cannot be pre-empted by other processes. This mode is referred to here as supervisor-mode.

The key protection module 22 executes a sequence of processor instructions to place the processor 18 in supervisor-mode prior to activity with respect to the acquired memory. The key protection module 22 then performs write operations to the corresponding look-up table entry to allow access to the acquired memory. Once access to the acquired memory has been completed, the key protection module 22 flushes any sensitive data held on the stack and reverses the above process to modify the look-up table entry and prevent access to the memory.

The following description relates to an embodiment of the present invention for use in implementing an encryption system for a personal digital assistant (PDA) using Windows CE® as its operating system.

This is achieved by using the acquired memory (acquired and protected as discussed above) to store the key(s) for the encryption system.

Referring to FIG. 4, a number of high-level requirements were identified for the provision of PDA encryption such that security assurances could be achieved suitable for certification. The general preferred features are summarised as:
a) the product should be transparent to the user during normal product use;
b) the product should encrypt all data on all removable memory cards;
c) encryption should be performed with an algorithm and key length appropriate for UK restricted material;
d) mechanisms should be implemented for the protection of key material;
e) encryption overhead should be minimized; and
f) the product should be easy to install.

The wish for transparency and the encryption of all data is achieved by the development of filter drivers to filter all data written to and read from memory cards 30.

The filter device drivers (shims) 32 intercept all read and write operations made to the memory card device-drivers provided with the PDA. The approach taken is for the shims to communicate with a separate device driver 34 for cryptographic activity as shown in FIG. 4.

The use of a shim allows the general requirements a) and b) to be met, while the remaining requirements are addressed through the architecture of the separate driver, referred to as BC driver 36.

Encryption algorithm options for baseline can include 3DES (Data Encryption Standard), AES (Advanced Encryption Standard) and a CESG proprietary algorithm. AES might be preferred for its performance advantages and its applicability to the commercial sector. A 128-bit key is deemed appropriate for baseline certification.

The principal technical challenge identified by CESG relates to requirement d). This involves providing sufficient control and protection of the encryption key. The requirement provides a significant challenge in a pocket PC (Windows CE®) environment due to the memory architecture adopted. Additionally, the operating system lacks the security architecture common to the Windows NT/2000® operating systems. The embodiments described herein address these issues.

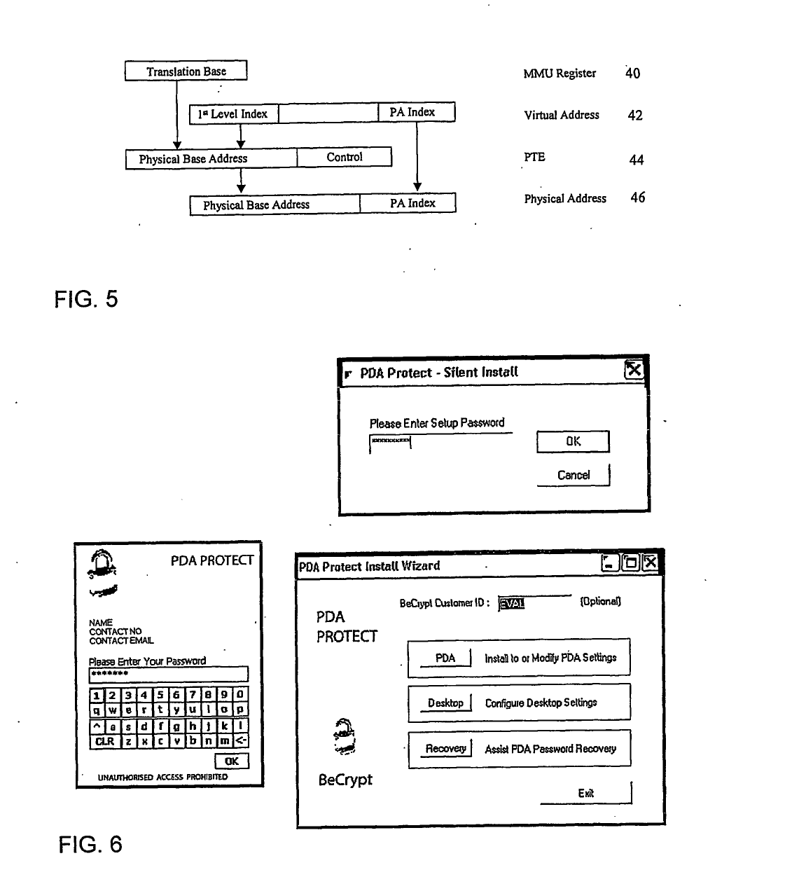

Referring now also to FIG. 5, the system provides protection of an installed encryption key by acquiring a section 12 of device memory 10 and applying protection to the memory 10 such that other applications 38 cannot access the memory 10 either through malicious or accidental activity. The system locates and manipulates the tables used by the operating system to initialize the memory management unit (MMU) 16 and maintain virtual to physical address mappings. The system obtains and hides at least a portion of physical memory 10 from the operating system by removing entries corresponding to the portion of memory from a list of available physical pages. The preferred embodiment also applies protection to memory by directly manipulating the MMU registers 40.

The process of modifying the appearance of memory 10 to the operating system 14 is outlined below, starting with an overview of the Memory Management unit.

Memory management is the ability to manage the system address space. A memory-managed address space as seen by a program running under Windows CE is referred to as a virtual address space 42. A virtual address is then translated by the system into a physical address 46 prior to accessing memory.

Memory management provides address translation and provides a persistent state following a faulting (uncompleted) memory access. Additionally, the MMU 16 will provide access control functionality made use of by the operating system 14.

Address translation is performed using page tables, which can involve multiple steps, dependent upon the granularity of the translated page size. A single-level lookup is illustrated in FIG. 5 (for a two level look-up example).

A translation base value is combined with the first-level index to provide the address of a page table entry (PTE) 44. This entry then provides the physical base, which is concatenated with the physical address index to provide the required physical address 46. Additional fields within the page table entry 44 contain access control information for the MMU model.

To enhance system performance, the processor 18 implements a cache of address mapping entries in translation look-aside buffer 20.

Access to the physical memory 10 is achieved by locating the data structures created by the operating system 14 during the initialisation of the MMU 16. The system modifies the VA (42)=>PA (46) mappings, and removes a physical address 46 entry from a (linked) list maintained by the operating system 14, effectively reducing the memory that the system ‘believes’ is available.

This provides a memory area reserved for use by the system. However, it remains possible that a rogue or malicious application could locate the physical page and tamper or copy the key. The system therefore implements protection of the memory area as described below.

To provide protection of the product encryption key, the BC Driver 36 will modify the MMU tables so that the physical memory 10 holding the AES keys is protected from access. Through access to MMU registers sections and pages for both privileged and non-privileged program execution can be protected using access permissions (AP bits), allowing no_access, read_only, or read_write permissions for supervisor and user modes. This is achieved by initialising a section of the MMU tables described above so that AES key memory is rendered not accessible by any code. When access to the keys is needed by the AES algorithm implemented by the system, the MMU tables will be modified to allow access to the keys.

This presents a second problem, as processes within a multi-tasking environment may normally be “pre-empted” such that they are placed in a suspended state, allowing another process to execute.

Encryption is required to be performed in a non pre-emptive manner. In the present embodiment, the driver includes some assembly language code which emulates mechanisms typically employed by the operating system to allow code to be executed in a non pre-emptive manner.

FIG. 6 shows an example of user interface for requiring the input of a user password to allow for decryption of encrypted data. The interface provides for access only by entry of the correct password 50, requirement to provide another password for modifying the system set up 52 and for the installation or modification of PDA settings, configuring of desktop settings and the assistance of PDA password recovery 54, using mechanisms and procedures known in the art.

The embodiments described provide an encryption product that address a number of vulnerabilities inherent in operating systems used in a number of electronic devices. They can provide transparent encryption with sufficient control over key material, by exploiting the memory management model employed by processor of such devices.

The embodiments described herein can provide a high level of security assurance, a system which is transparent to the user and which can support remote deployment and configuration. They can therefore offer a simple way of providing good security protection for data on lost or stolen computers and other electronic devices. Authentication preferably occurs at boot time using password hashing with the option of secondary authentication (be it by way of second code or additional component).

1-22. (canceled)

23. A security system for an electronic device having a memory, the security system comprising means arranged to interact with the electronic device to acquire at least a portion of the memory of the electronic device, and an access system arranged to control access to the acquired memory independently of an operating system of the electronic device.

24. A system as claimed in claim 23, wherein the means arranged to interact with the electronic device is arranged to interact directly with the operating system.

25. A system as claimed in claim 23, wherein the means arranged to interact with the electronic device is arranged to interact with a memory management unit of the device.

26. A system as claimed in any claim 25, wherein the memory management system is manipulated to remove references to the acquired memory.

27. A system as claimed in claim 25, wherein the access system is arranged to control access to at least selected registers of the memory management unit.

28. A system as claimed in claim 23, wherein the acquired memory is hidden from the operating system.

29. A system as claimed in claim 23 comprising a filter driver.

30. A system as claimed in claim 23, wherein the electronic device comprises a selected one of a personal digital assistant (PDAs), a mobile telephone and a laptop.

31. A system as claimed in claim 23, wherein the access system is arranged to protect at least selected registry settings associated with the acquired memory such that they cannot be modified by other applications.

32. A system as claimed in claim 31, wherein the access system is arranged to maintain a copy of correct values for the selected registry settings, monitor the registry settings and reset registry settings where incorrect values are detected.

33. A system, as claimed in claim 23, wherein the memory acquired, is used to store the encryption/decryption key or keys of the encryption system.

34. A method of protecting at least a portion of a memory of an electronic device comprising the steps of:
interacting with the electronic device to acquire at least a portion of the memory of the electronic device and controlling access to the acquired memory independently of an operating system of the electronic device.

35. A method as claimed in claim 34, wherein the step of interacting includes interacting directly with the operating system.

36. A method as claimed in claim 34, wherein the step of interacting includes interacting directly with a memory management unit of the device.

37. A method as claimed in any claim 36, further comprising the step of manipulating the memory management unit to remove references to the acquired memory.

38. A method as claimed in claim 36, further comprising the step of controlling access to at least selected registers of the memory management unit.

39. A method as claimed in claim 34, further comprising the step of hiding thee acquired memory from the operating system.

40. A method as claimed in claim 34, further comprising the steps of protecting at least selected registry settings associated with the acquired memory such that they cannot be modified by other applications.

41. A method as claimed in claim 40, further comprising the steps of maintaining a copy of correct values for the selected registry settings, monitoring the registry settings and resetting registry settings where incorrect values are detected.

42. A program storage device readable by a machine and encoding a program of instructions for interacting with an electronic device to acquire at least a portion of the memory of the electronic device and for controlling access to the acquired memory independently of an operating system of the electronic device.
